(19) United States
(12) Patent Application Publication
(10) Pub. No.: US 2016/0307123 A1
(43) Pub. Date: Oct. 20, 2016

(54) METHODS AND SYSTEMS FOR LEGACY COMPATIBLE SOFTWARE

(71) Applicant: ZAG HOLDINGS INC., Toronto (CA)

(72) Inventors: Igal ROYTBLAT, Toronto (CA); Jonathan HALDANE, Toronto (CA)

(21) Appl. No.: 15/101,076

(22) PCT Filed: Nov. 27, 2014
(86) PCT No.: PCT/CA2014/051137

§ 371 Date: Jun. 2, 2016

Related U.S. Application Data
(60) Provisional application No. 61/910,855, filed on Dec. 2, 2013.

(51) Int. Cl. G06Q 10/02; H04L 29/08

(52) U.S. Cl. CPC G06Q 10/02; H04L 67/02; H04L 67/16; H04L 67/32; G06Q 50/14

(57) ABSTRACT

Embodiments of the present technology relate to integrating web services into agent terminal systems. In one embodiment, a method includes monitoring commands on a native global distribution system desktop, the commands being input into native global distribution system (GDS) desktop in a native mainframe format, launching a user interface window of a web application for a map-based shopping and booking system in either a User Interface or in a native window when a travel request includes a trigger, providing the user interface window a local HTTP server with which to interface when running in the User Interface, and orchestrating communication between the native global distribution system (GDS) desktop, GDS web services, and the user interface window.

### CROSS REFERENCE TO RELATED APPLICATIONS

This application claims the priority benefit of U.S. Provisional Application Ser. No. 61/910,855, filed on Dec. 2, 2013, titled “METHODS AND SYSTEMS FOR LEGACY COMPATIBLE SOFTWARE”, which is hereby incorporated by reference herein in its entirety, including all references cited therein.

### FIELD OF THE PRESENT TECHNOLOGY

The present technology relates generally to travel booking, and more specifically, but not by limitation, to systems and methods that incorporate a gateway services module on an agent desktop. The gateway services module coordinates communications between GDS (Global Distribution System) web services, GDS mainframe terminal desktop, and third party, location-based travel services. An agent can use the GDS mainframe terminal desktop (e.g., legacy interface) to input native mainframe requests and the gateway services module can convert these native mainframe requests into queries that can be fulfilled by the GDS web services. In this way, the agent can use a familiar GDS mainframe terminal desktop but receive a more robust rather than a simple terminal output from GDS web services, without requiring the agent to learn to use the GDS web services.

### SUMMARY

Embodiments of the present technology include a method, comprising: (a) receiving, using a gateway services module executing on an agent terminal, commands from the agent terminal, the commands comprising travel parameters in a native mainframe format, wherein at least a portion of the commands also comprises a trigger; and (b) evaluating, using the gateway services module, each of the commands, wherein when a travel request comprises the trigger, the gateway services module: (i) providing the converted web services format request to a web services system of a global distribution system; and (ii) receiving from the web services system a response to the request; and (iii) providing the response in a displayable format on the agent terminal.

Other embodiments of the present technology include a method, comprising: (a) executing on an agent terminal a gateway services module, the gateway services module being configured for: (i) monitoring commands on a native global distribution system desktop, the commands being input into native global distribution system (GDS) desktop in a native mainframe format; (ii) launching a user interface window of a web application for a map-based shopping and booking system in either a User Interface or in a native window when a travel request includes a trigger; (iii) providing the user interface window a local HTTP server with which to interface when running in the User Interface, and (iv) orchestrating communication between the native global distribution system (GDS) desktop, GDS web services, and the user interface window.

Additional embodiments of the present technology include a system, comprising: (a) a processor; and (b) a gateway services module controlled by the processor, the gateway services module comprising: (i) a local global distribution services connector that communicates with a global distribution services terminal that, in turn, communicates with a mainframe of a global distribution system; and (ii) a global distribution services web services client that communicates with web services of the global distribution system; the gateway services module being configured to: (1) receive commands input by an agent into the global distribution services terminal, the commands being formatted for the mainframe of the global distribution system, wherein at least a portion of the commands also comprise a trigger; (2) detect the trigger in a travel request; (3) convert the format of the travel request into a web services format request; (4) transmit through the global distribution services web services client, the web services format request to the web services of the global distribution system; and (5) receive from the web services system a response to the request.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a high level schematic diagram of computing architecture for practicing aspects of the present technology.

FIG. 2 is a flowchart of a method that is executed in accordance with the present technology.

FIG. 3 is a signal flow diagram of a method for hotel shopping and booking that uses the principles of the present technology.

FIG. 4 is a signal flow diagram of another example method for hotel shopping and booking that uses the principles of the present technology.

FIG. 5 is a flowchart of a method that is executed in accordance with the present technology.

FIG. 6 is a schematic diagram of a computing machine that is used to implement embodiments according to the present technology

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

For context, most travel agent shopping and booking systems are provided by a Global Distribution Systems (“GDSs”). The three major GDSs include Sabre®, Travelport® and Amadeus®, which are based on mainframe systems from the 1970s and even the 1960s.

GDSs provide two methods of integration. First, the GDS provides a desktop level integration on the local machine (e.g., agent terminal) to a native text-based mainframe terminal. Second, the GDS provides a server-side suite of web services that allow execution of all the text-based commands in a well-formatted data structure. Traditionally, agents will work solely on native desktop clients, such as Sabre Red, Go!Res and others, and OTAs (Online Travel Agency) such as expedia.com, hotels.com, kayak.com and others will use solely web services.

The GDS desktop interface (e.g., native desktop environment) is a legacy text-based system. Over many years the format has evolved to introduce new services and options as needed. As a result the format became highly complex and very cryptic in form. The learning curve to become proficient at this format became very long and experts still need constant assistance with proper formatting.

The native desktop environment used by the travel agent requires knowledge and training in construction of native format requests. That is the GDS mainframe requires as input, fairly arcane and text-based input from the travel agent. For example, “HOTYYZ/15JAN-27JAN2”, roughly equates to a request for hotels near the Toronto Pearson Airport for dates equal to January 15th through the 27th. Depending on the complexity of the query, the text-based request input by a travel agent into the native text-based mainframe terminal can be much more complex, which requires knowledge of numerous commands. Travel agents spend time and effort memorizing and becoming proficient with these commands.

The GDS mainframe provides responses back to the native text-based mainframe terminal in arcane, text-based formats.

Conversely, while web services of a GDS provide more robust results, these web services are not configured to process the arcane native format inputs used by the travel agent on their native text-based mainframe terminal.

The content gathered by web services can be used as the basis for creating map-based results by third party services, as will be described in greater detail herein.

The present technology provides a gateway that runs on the travel agent desktop. This gateway integrates web service functionality into the native desktop environment, allowing seamless transition to modern, map-based shopping and booking systems.

In one embodiment, the gateway receives native text-based input that is used by the GDS mainframe, converts the native text-based input from its native format into a query that is structured for use with the GDS web services. In another embodiment, the native text based input is forwarded to the web services server without conversion.

Advantageously, the gateway allows the travel agent to use the more familiar native text-based input, but receive, if available, map-based shopping and booking features provided by the GDS web services. The gateway thus requires minimal training and minimal habitual impact to the travel agent.

In another advantage, the present technology and architecture was designed in such way that sensitive private and payment information will not leave the secure agency network and access third party servers. This way, PCI and HIPAA compliance are inherently supported. That is, the third party servers are not subject to PCI or HIPPA requirements because they are not privy to sensitive private and payment information. The GDS system and travel agent desktop are the only entities that have access to the sensitive private and payment information. Third party service providers are more likely to use the systems and methods of the present technology because PCI and HIPPA compliance are onerous. Removing this compliance aspect reduces barriers to system usage.

These and other advantages of the present technology are provided below with reference to the collective drawings.

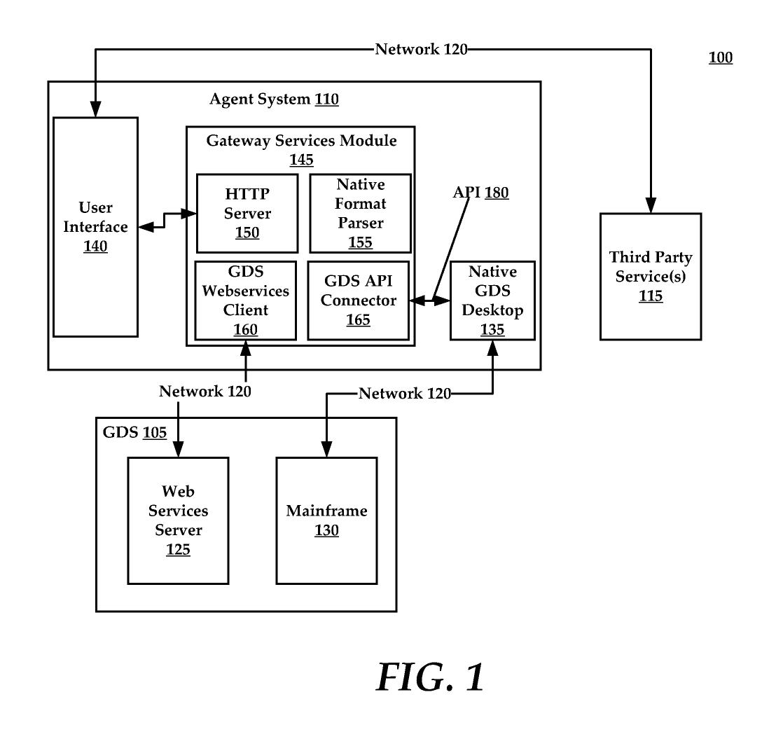

FIG. 1 is a high level schematic diagram of a computing architecture (hereinafter architecture 100) of the present technology. The architecture 100 comprises a global distribution system (GDS) 105, an agent system 110, and a third party service 115. These components can be communicatively coupled over any one or combination of public or private networks, such as network 120.

The GDS 105 comprises a web services server 125 and a mainframe 130. The GDS can include any known GDS such as Sabre®, Travelport®, or Amadeus®. Each GDS requires a unique native format for travel-related requests. Examples of travel service requests include flight requests and hotel requests.

Native format requests are input at a User Interface 140 such as a browser or other native user interface on the agent system 110. The native format requests can be forwarded to a terminal interface (Native GDS Desktop) in some embodiments, such as when the native format request does not include a trigger (as described in greater detail below). As mentioned above, these unique native format requests often comprise cryptic and arcane commands that are configured to be read and understood by the mainframe 130. The mainframe 130 likewise outputs only text-based output in response to requests from the native GDS desktop.

In contrast, the web services server 125 will provide responses to queries for travel services such as flights and hotels, but the output of the web services server 125 will be more robust rather than a simple terminal output.

To be sure, the query structure used to query the web services server 125 is different from the text-based input used to query the mainframe 130. Thus, to use the web services server 125, the travel agent must learn and use a completely different set of commands for the web services server 125, as opposed to the native format requests used for the mainframe 130.

The agent system 110 comprises a native GDS desktop 135, a User Interface 140, and a gateway services module 145.

The native GDS desktop 135 is a terminal interface that runs on the agent system 110. The native GDS desktop 135 receives the native format requests described above. In some embodiments, the native GDS desktop 135 is coupled to the gateway services module 145 using a local application programming interface (API) 180.

The User Interface 140 provides the agent system 110 with access to additional types of travel information through third party systems, such as third party service 115. While a GDS provides flight and hotel booking options, other services and products outside the GDS include rental cars, entertainment, and other products and services. In one example, the third party service 115 includes a location-based travel services system, such as the system provided by Zoomandgo.com Inc., which provides map-based hotel booking services.

The present technology advantageously provides interoperability between the web services server 125 and the mainframe 130, allowing a travel agent to use their native GDS desktop. The gateway services module 145 provides these functionalities.

In general, the gateway services module 145 is configured to monitor communications (e.g., requests) on the native GDS desktop 135, launches one or more windows either in the User Interface 140 or in a native window when needed, and provides the User Interface a local HTTP server 150 to interface when running in the User Interface 140.

The gateway services module 145 also orchestrates complex scenarios of communications between native GDS desktop 135, web services server 125, and the User Interface 140.

In some embodiments, the gateway services module 145 uses a single command component, referred to as a trigger, to execute methods of the present technology, including converting native format text inputs used with the native GDS desktop 135 into a format can be used by the web services server 125 to fulfill the travel request.

A trigger can include a keyword, a symbol, or combinations thereof. In one example, a native format text input would include “HOTYYZ/15JAN-27JAN2”, as described above. A trigger can be included as follows ““HOTYYZ/15JAN-27JAN2**MAP”, where **MAP is the trigger. In one embodiment, the trigger is appended to the native format text input. In another embodiment, the trigger can be used as a command component, such as when MAP is input into the native GDS desktop 135. The next native format text input would be converted into a format that can be used by the web services server 125.

In some embodiments, the trigger can include any cryptic, native format keyword or keywords.

Thus, a single command component, referred to as a trigger, is used to launch the gateway services module 145 into action, either standalone or combined with a native GDS format. Thus, the gateway services module 145 is used to “hook” into the regular agents' workflow without overloading the agents with new formats. The gateway services module 145 provides interoperability between the native GDS desktop 135 and the web services server 125, transparent to the travel agent. The travel agent submits native format requests to the native GDS desktop 135, and if available, robust responses are returned from the web services server 125 and/or the third party service 115.

In some embodiments, the gateway services module 145 comprises a native format parser 155 that intercepts native format requests that are input into the native GDS desktop 135. The native format parser 155 separates requests into meaningful components. The native format parser 155 may also pass the parsed elements to the User Interface 140 to be automatically incorporated into display options.

In some embodiments, the native format parser 155 converts the native format request into a format that is acceptable for user with the web services server 125. In other embodiments, the commands are not converted but are transmitted directly to the web services server 125.

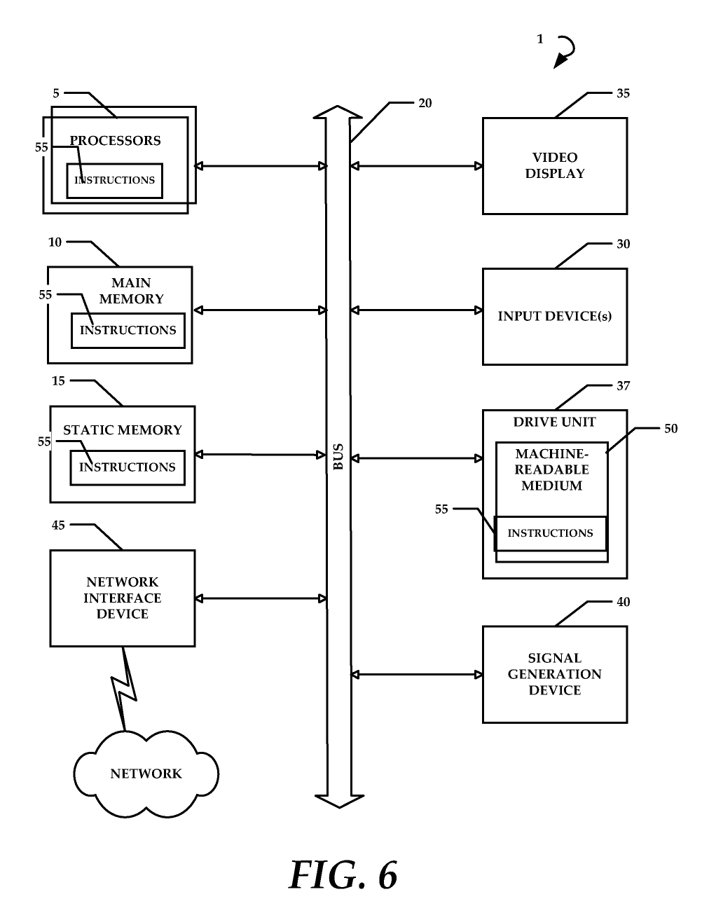

In some embodiments, the gateway services module 145 also comprises a GDS webservices client 160, a local GDS API connector 165, and a local HTTP (hyper text transfer protocol) server 150. The gateway services module 145 can be stored in memory of the agent system 110 and executed by a processor of the agent system 110. An example processor and memory are illustrated in FIG. 6.

As used herein, the terms “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The GDS webservices client 160 interfaces with the web services server 125 for the GDS 105. Converted commands, generated by the native format parser 155, are provided to the web services server 125 using the GDS webservices client 160.

The local GDS API connector 165 receives native format requests from the native GDS desktop 135. The local HTTP server 150 provides a communicative connection between the User Interface 140 and the third party service 115.

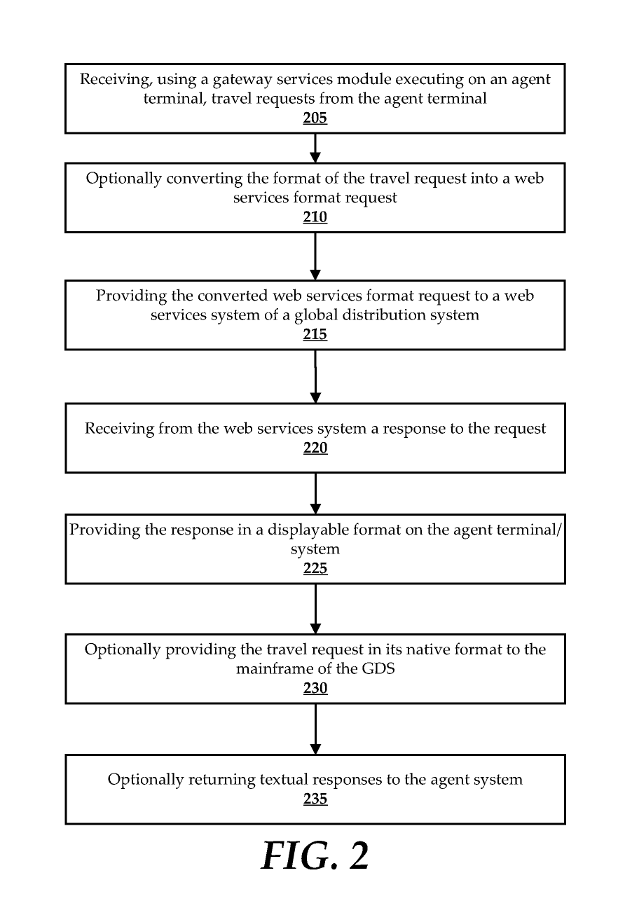

FIG. 2 illustrates an example method of the present technology. The method comprises receiving 205, using a gateway services module executing on an agent terminal, commands from the agent terminal. As mentioned above, the commands each comprise travel parameters (individual commands or command segments) in a native mainframe format. One or more of these commands include a trigger, which causes the gateway services module to execute further steps of the method. It will be understood that the travel agent enters the trigger when they desire to obtain map-based responses instead of just text-based responses.

In one example, a travel request includes a string of commands that are input into the native GDS desktop 135 by the agent, as well as the trigger. When the trigger is present, the gateway services module further executes the method by optionally converting 210 the format of the travel request into a web services format request.

Next, the method includes the gateway services module providing 215 the converted web services format request to a web services system of a global distribution system.

The method includes the gateway services module receiving 220 from the web services system a response to the request. If the web services system of the GDS was able to obtain responses to the request, the method includes the gateway services module providing 225 the response in a displayable format on the agent terminal/system. For example, the web services response can be displayed on a native window or User Interface 140 of the agent system.

Alternatively, if the web services system was unable to fulfill the request, the method includes providing 230 the travel request in its native format to the mainframe of the GDS. The method would then include the mainframe of the GDS returning 235 textual responses to the agent system. That is, the mainframe of the GDS provides textual responses to the native GDS terminal on the agent system when map-based responses are unavailable. To be sure, steps 230 and 235 are optional steps that are executed only when no web services requests are available or desired.

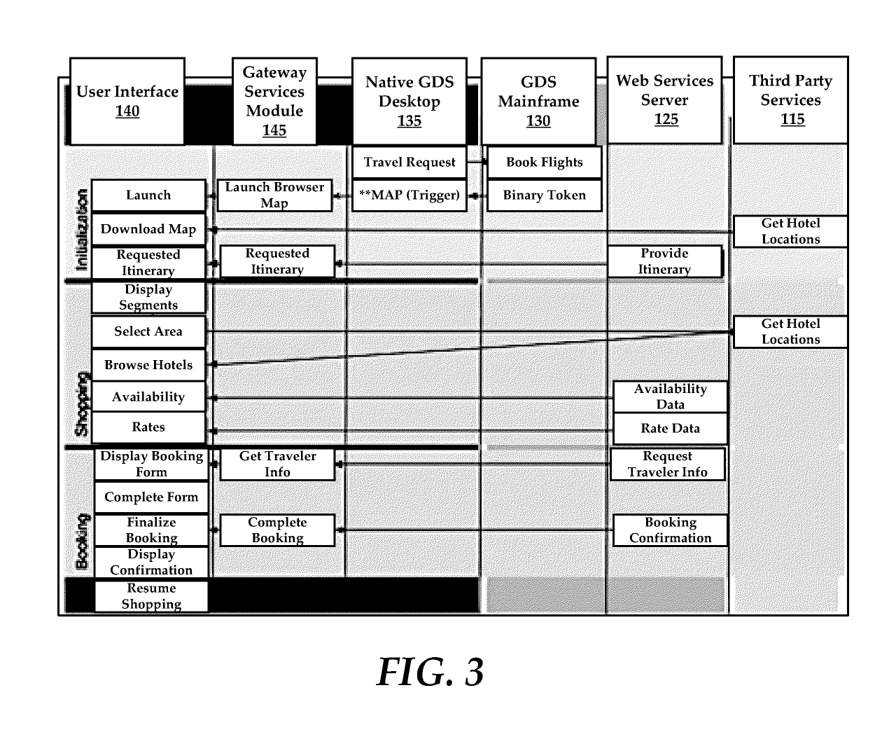

FIG. 3 is a signal flow diagram of a method for hotel shopping and booking that uses the principles of the present technology. It will be noted that this flow diagram involves the use of a Saber GDS that allows for session sharing (creation and use of Binary Token). The initial segments of the flow diagram relate to an initialization process for enabling a hotel shopping process, and an eventual booking process.

In this embodiment, a travel request is input at the native GDS desktop 135 by a travel agent. This includes the native format request that includes a “**MAP” trigger. A flight portion of the native format request is provided to the GDS mainframe 130, where the the GDS mainframe 130 books the requested flights. The GDS mainframe 130 returns a binary token that can be used to facilitate session sharing for multiple agents/users.

Because the native format request includes the trigger, the gateway services module 145 will cause the User Interface 140 to launch in preparation of displaying map-based search results.

A map is downloaded for the User Interface 140 from the hotel locations searched by the third party services 115. It will be understood that the native format request, when received at the native GDS desktop 135, can be provided in various directions. First, the native format request is provided to the GDS mainframe 130. A converted version of the native format request is provided to the web services server 125 and the converted request is also provided to the third party services 115. The third party services 115 can fulfill location-based parts of the request, while the web services server 125 fulfills robust and structured responses for hotels as a requested itinerary.

The gateway services module 145 provides the requested itinerary for display on the User Interface 140.

In the hotel shopping process, travel segments are displayed on the User Interface 140. Travel segments can include one or more portions of a travel experience. For example, a traveler may travel to a single location or multiple locations. In another example, the traveler may travel to a single location, but divide their trip in such a way that multiple hotels are required.

In any event, a location where the hotel is needed can be selected at the User Interface. In general, the User Interface 140 provides the travel agent with various GUIs that allow the travel agent to view and select travel segments, select desired areas, browse or view hotels, view availability and rates, as well as other processes.

In this example, the third party services 115 obtains hotel location information from the selected area and provides the selected hotels in a GUI to the travel agent. The third party services 115 provides contextual information for the hotel such as pictures, reviews, descriptive data, and other robust information. This information is combined with availability and rate information gathered from the web services server 125.

The booking process includes the filling of forms and confirming of reservations for the selected hotels. Because this booking process involves sensitive information such as credit card numbers, social security numbers, names, and so forth, the GDS and agent system are subject to PCI and HIPPA compliance requirements. To be sure, the third party services 115 has no access to any sensitive information and is thus exempt from PCI and HIPPA compliance requirements.

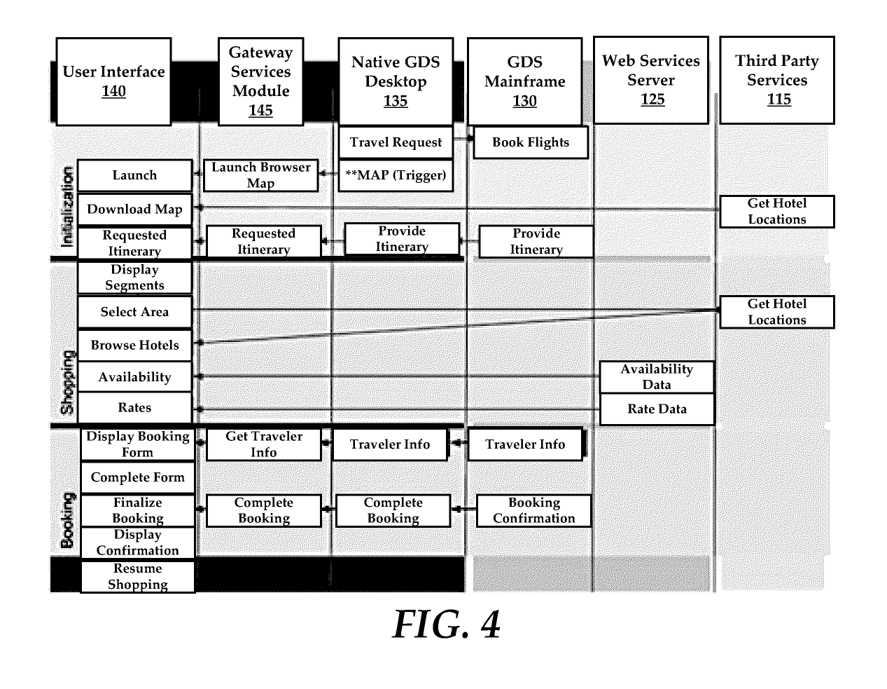

FIG. 4 is a signal flow diagram of a method for hotel shopping and booking that uses the principles of the present technology. It will be noted that this flow diagram involves the use of a Travelport or Amadeus GDS, neither of which allows for session sharing. The method is similar to the method of FIG. 3 except that no binary token is generated by the GDS mainframe 130.

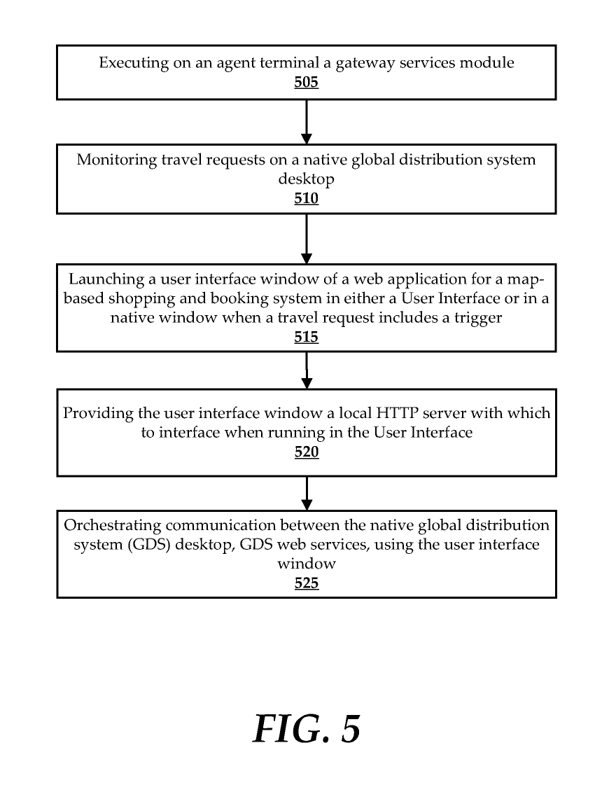

FIG. 5 is a flowchart of an example method executed in accordance with certain aspects of the present invention. The method is executed by an agent system that comprises a gateway services module that has been stored on the agent system. The gateway services module is controlled by a processor of the agent system.

In one embodiment, the method comprises executing 505 on an agent terminal a gateway services module. In some embodiments, the gateway services module further executes steps of the method such as monitoring 510 commands on a native global distribution system desktop. It will be understood that the commands are input into native global distribution system (GDS) desktop in a native mainframe format.

Next, the method includes launching 515 a user interface window of a web application for a map-based shopping and booking system in either a User Interface or in a native window when a travel request includes a trigger.

The method also comprises providing 520 the user interface window a local HTTP server with which to interface when running in the User Interface.

Next, the method includes orchestrating 525 communications between the native global distribution system (GDS) desktop, GDS web services, using the user interface window. This includes, for example, converting native mainframe requests to web services formatted requests, returning web services responses to the web services formatted requests and, in some instances, returning mainframe responses when no web services responses exist. Again, these features are facilitated through the user interface window, allowing the travel agent to receive web services responses instead of (or in addition to) mainframe responses. This process allows the travel agent to receive robust and information rich responses, rather than simple textual response. Furthermore, third party location services can augment the responses as desired.

FIG. 6 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
receiving, using a gateway services module executing on an agent terminal, commands from the agent terminal, the commands comprising travel parameters in a native mainframe format, wherein at least a portion of the commands also comprise a trigger; and
evaluating, using the gateway services module, each of the commands, wherein when a travel request comprises the trigger, the gateway services module:
providing the converted web services format request to a web services system of a global distribution system; and
receiving from the web services system a response to the request; and
providing the response in a displayable format on the agent terminal.

2. The method according to claim 1, further comprising executing a web application or User Interface of the agent terminal to display the map-based response.

3. The method according to claim 1, wherein the gateway services module allows an agent, at any time, to revert back to a mainframe terminal to proceed with workflow.

4. A method, comprising:
executing on an agent terminal a gateway services module, the gateway services module being configured for:
monitoring commands on a native global distribution system desktop, the commands being input into native global distribution system (GDS) desktop in a native mainframe format;
launching a user interface window of a web application for a map-based shopping and booking system in either a User Interface or in a native window when a travel request includes a trigger;
providing the user interface window a local HTTP server with which to interface when running in the User Interface; and
orchestrating communication between the native global distribution system (GDS) desktop, GDS web services, using the user interface window.

5. The method according to claim 4, wherein the gateway services module allows an agent, at any time, to revert back to a mainframe terminal to proceed with workflow.

6. The method according to claim 5, wherein the gateway services module is further configured to convert the native mainframe format of the travel request into a GDS web services request.

7. The method according to claim 6, further comprising displaying a response from the GDS web services in the map-based user interface window.

8. The method according to claim 7, further comprising providing a web application that provides location-based options for the travel request, from a third party system, that are in addition to content included in the map-based response.

9. The method according to claim 8, wherein fulfillment of the travel request by booking occurs between the agent terminal and the global distribution system only such that the third party server does not receive sensitive information of a traveler.

10. A system, comprising:
a processor; and
a gateway services module controlled by the processor, the gateway services module comprising:
a local global distribution services connector that communicates with a global distribution services terminal that, in turn, communicates with a mainframe of a global distribution system; and
a global distribution services web services client that communicates with web services of the global distribution system;
the gateway services module being configured to:
receive commands input by an agent into the global distribution services terminal, the commands being formatted for the mainframe of the global distribution system, wherein at least a portion of the commands also comprises a trigger;
detect the trigger in a travel request;
convert the format of the travel request into a web services format request;
transmit through the global distribution services web services client, the travel request to the web services of the global distribution system; and
receive from the web services system a response to the travel request.

11. The system according to claim 10, wherein the gateway services module further comprises a local server interface that couples with a local server that provides a web application that provides location-based options for the travel request, from a third party system, that are in addition to content included in the response.

12. The system according to claim 10, wherein fulfillment of the travel request by booking occurs between the agent terminal and the global distribution system to shield the third party system from payment card industry (PCI) requirements.

13. The system according to claim 10, wherein the global distribution services web services client displays the response.

14. The system according to claim 10, wherein the local global distribution services connector is coupled with the global distribution services terminal using a local application programming interface (API).

15. The system according to claim 10, wherein the trigger comprises a keyword that is appended to the travel request that is in the format for the mainframe.

16. The system according to claim 10, wherein the travel request is a text string of commands.

17. The system according to claim 10, wherein the global distribution system is selected from any of Sabre®, Travelport®, or Amadeus®, wherein the travel request is a string of commands formatted for the selected global distribution system.

18. The system according to claim 17, wherein gateway services module comprises a native parser that parses the travel request in the native format into the web services format request based on the selected global distribution system.
